(19) United States
(12) Patent Application Publication
(10) Pub. No.: US 2006/0207185 A1
(43) Pub. Date: Sep. 21, 2006

(54) Pivot sash block and tackle locking channel

(76) Inventors: L. Dale Shuler, Alderson, WV (US); Neeman Malek, Lorraine (CA)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/243,957

(22) Filed: Oct. 4, 2005

Related U.S. Application Data
(60) Provisional application No. 60/615,723, filed on Oct. 4, 2004.

(51) Int. Cl. E05F 1/00

(52) U.S. Cl. 49/445

(57) ABSTRACT

In a window frame track, a U-shaped channel having a front wall connecting a pair of side walls includes a block, a cam rotatably mounted in the block, an axial opening in the cam generally concentric with an opening through the front wall, a sash attached to the cam by a bar extending through the opening through the front wall into the axial opening in the cam, a plate extendable from the block axially against said track contacting the cam prevents vertical movement of the U-shaped cannel in the track when the sash is rotated out of the window frame.

### CROSS-REFERENCE TO RELATED APPLICATION

This patent application claims benefit under 35 U.S.C. §119(e) of copending, U.S. Provisional Patent Application Ser. No. 60/615,723, filed Oct. 4, 2004, the disclosure of which is incorporated by reference herein in its entirety.

### BACKGROUND OF THE INVENTION

1. Field of the Invention

The invention pertains to a sash balance system for a tilt-in window sash that locks the sash against vertical movement in a window frame when the sash is rotated out of the frame, say into a room for a cleaning of the sash light.

2. Description of the Prior Art

U.S. Pat. No. 6,679,000 Uken et al. patented Jan. 20, 2004 describes a snap lock balance shoe and system for a pivotable window.

### SUMMARY OF THE INVENTION

In a window frame track, a U-shaped channel having a front wall connecting a pair of side walls includes a block, a cam rotatably mounted in the block, an axial opening in the cam generally concentric with an opening through the front wall, a sash attached to the cam by a bar extending through the opening through the front wall into the axial opening in the cam, a plate extendable from the block axially against said track contacts the cam prevents vertical movement of the U-shaped channel in the track when the sash is rotated out of the window frame.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is cut away ¾ elevated side schematic view of a pivot sash block and tackle locking channel according to the invention, mounted in a window jamb track, attached by a pivot shaft to a window sash;

FIG. 2 is a ¾ elevated front schematic view of the pivot sash block and tackle locking channel of FIG. 1;

FIG. 3 is a ¾ elevated back schematic view of the pivot sash block and tackle locking channel of FIG. 1;

FIG. 4 is an exploded ¾ elevated front schematic view of one end of the pivot sash block and tackle locking channel of FIG. 1;

FIG. 5 is an exploded ¾ elevated back schematic view of one end of the pivot sash block and tackle locking channel of FIG. 1;

FIG. 6 is an exploded ¾ elevated front schematic view of the pivot sash block and tackle locking channel of FIG. 2 showing a cam rotated to a vertical sash position;

FIG. 7 is an exploded ¾ elevated back schematic view of the pivot sash block and tackle locking channel of FIG. 3 showing a cam rotated to a vertical sash position;

FIG. 8 is a schematic back view of the block and tackle mechanism in the channel of FIG. 3;

FIG. 9 is a ¾ front schematic view of a clip of FIG. 4 mounted on the channel of FIG. 4;

FIG. 10 is a ¾ back schematic view of the clip of FIG. 4 mounted on the channel of FIG. 4;

FIG. 11 is a top schematic view of a clip;

FIG. 12 is a bottom schematic view of the clip of FIG. 11;

FIG. 13 is a front ¾ elevated schematic view of the clip of FIG. 11;

FIG. 14 is a schematic side view of the clip of FIG. 11;

FIG. 15 is a schematic back view of a block;

FIG. 16 is a schematic side view of the block of FIG. 15;

FIG. 17 is a schematic front view of the block of FIG. 15;

FIG. 18 is a schematic cut away side view taken through A-A of the block of FIG. 15;

FIG. 19 is a schematic top view of the block of FIG. 15;

FIG. 20 is a front schematic view of a plate;

FIG. 21 is a side schematic view of the plate of FIG. 20;

FIG. 22 is a ¾ elevated front schematic view of the plate of FIG. 20;

FIG. 23 is a bottom schematic view of the plate of FIG. 20;

FIG. 24 is a back schematic view of a cam;

FIG. 25 is a bottom schematic view of the cam of FIG. 24;

FIG. 26 is a ¾ elevated front schematic view of the cam of FIG. 24;

FIG. 27 is a schematic side view of the cam of FIG. 24;

FIG. 28 is a schematic angle back view of the cam of FIG. 24;

FIG. 29 is a ¾ front schematic view of a clip mounted on one end of a pivot sash block and tackle locking channel according to the invention;

FIG. 30 is a ¾ back schematic view of the clip of FIG. 29 mounted on the channel of FIG. 29; and

FIG. 31 is an exploded ¾ elevated back schematic view of the clip of FIG. 29 mounted on the channel of FIG. 29.

### DETAILED DESCRIPTION OF THE DRAWINGS

Before explaining the invention in detail, it is to be understood that the invention is not limited in its application to the detail of construction and arrangement of parts illustrated in the drawings since the invention is capable of other embodiments and of being practiced or carried out in various ways. It is also to be understood that the phraseology or terminology employed is for the purpose of description only and not of limitation.

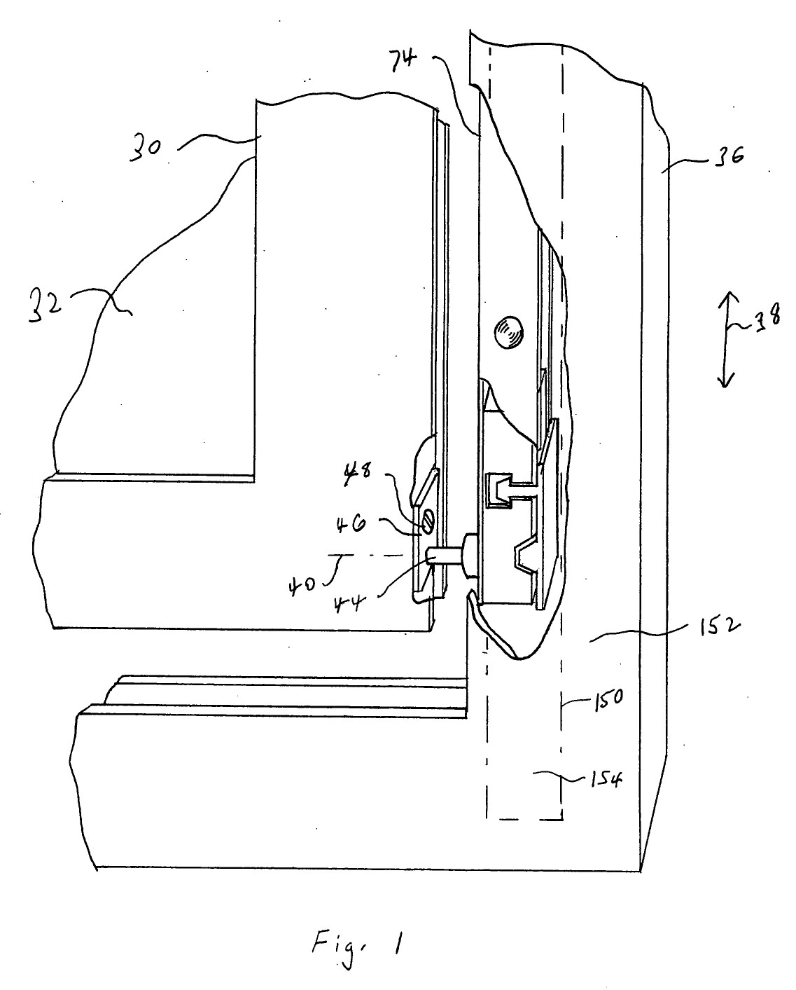

Referring to FIG. 1-5, sash 30 is mounted in window frame 36 so that it can move vertically 38 when the sash is in the frame and the plane of the sash is parallel to the plane of the frame. Sash 30 is also designed to rotate out of the plane on the frame on axis 40 of bar 44. Bar 44 is fixedly attached to the sash by bracket 46 and screw 48.

Bar 44 is rectangular in cross section so that the bar closely fits rectangular opening 50 in barrel 54 of cam 56. Opening 72 through front wall 74 of channel 70 is aligned with rectangular opening 50 for receiving bar 44 through openings 72 and 50. Preferably channel 70 is steel. Preferably channel 70 is U-shaped in cross section.

Cam 56 barrel 54 rotates in opening 60 in block 64.

Block 64 is preferably surrounded by sides 82, 84, and end 86 of steel channel 70.

As best shown in FIG. 5, fingers 92, 94 of plate 90 slide axially 95 into grooves 102, 104 respectively. Hooked ends 106, 108 prevent fingers 92, 94 from axially leaving the channels.

Preferably block 64 closely fits to sides 82, 84 such that fingers 92, 94 in grooves 102, 104 cannot bend laterally out of grooves 102, 104 and pass outward by stops 110, 111.

Block 64 is fastened into channel 70 by rivet 116 through holes 120, 124 through channel sides 84, 82 and hole 122 through the block.

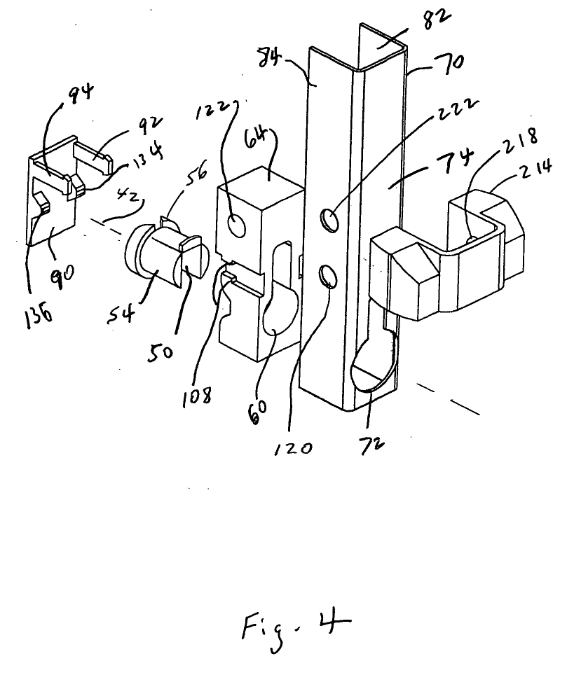

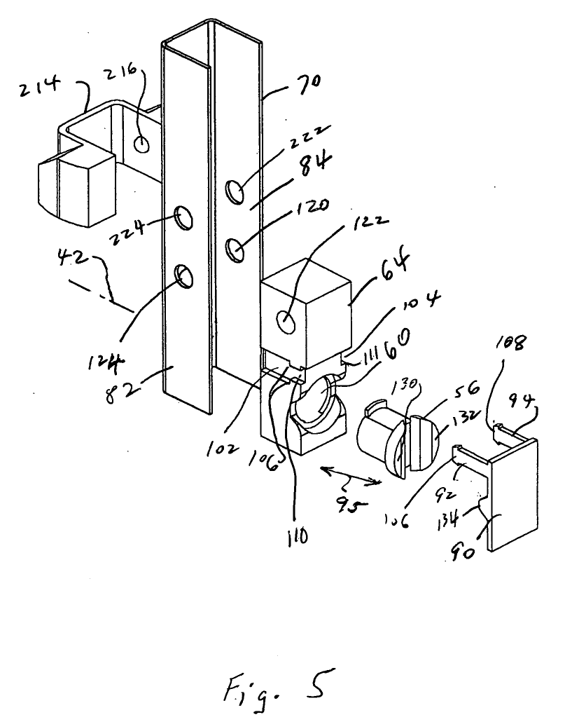

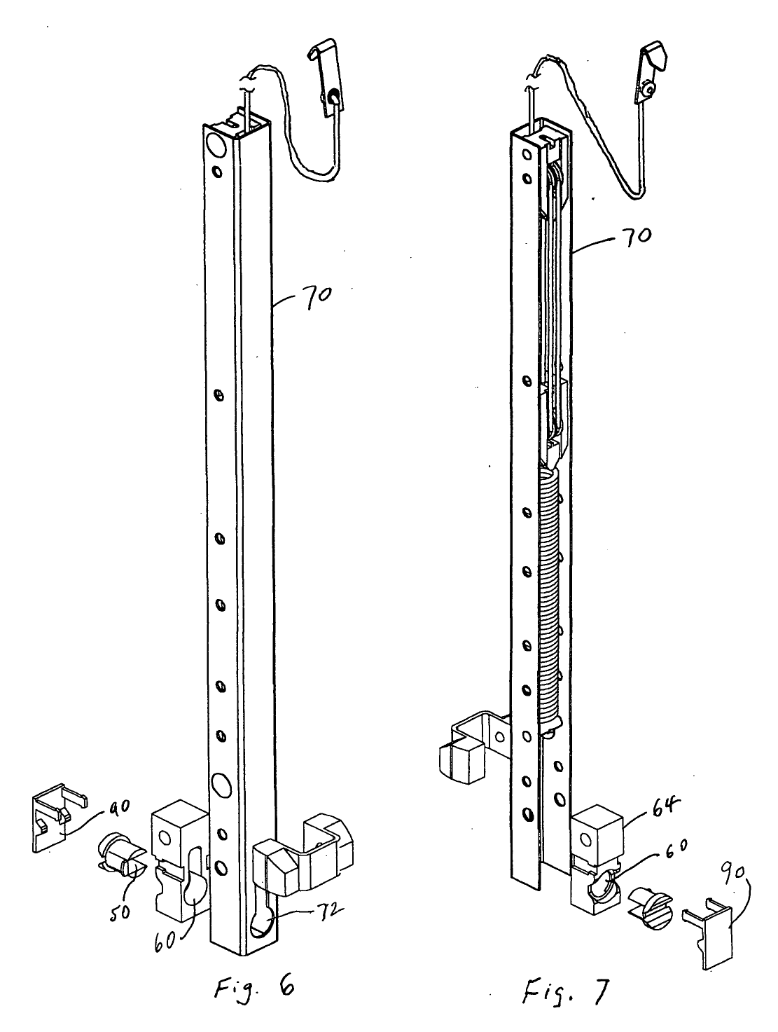

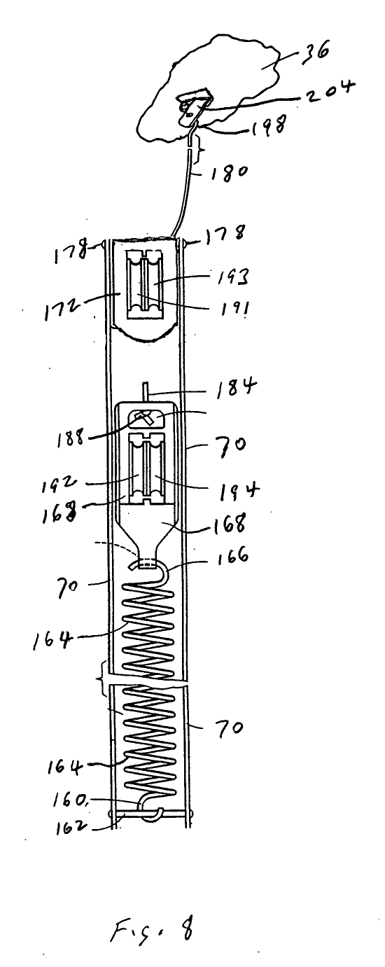

In FIGS. 4, 5, and 9, cam 56 is positioned around axis 42 by bar 44 by sash 30 as if the sash is extending into a room so that the plane of the sash is about 90 degrees to the plane of the frame, e.g., a typical position for cleaning the sash lights 32. At this cam position, faces 130, 132 pressing on riders 134, 136 force plate 90 back from block 64 so that plate 90 presses axially against track 154 back wall 150 of jamb 152 so that the plate prevents vertical movement of block 64 which by their interconnection with block 64 prevents vertical 38 movement of bar 44 and of sash 30 along track 154.

In FIGS. 1, 2, 6 and 7, cam 56 is positioned around axis 42 by bar 44 by sash 30 in window frame 36 standing vertically in the window frame, the plane of the sash parallel to the plane of the window frame and parallel to track 154. At this came position, riders 134, 136 are between faces 130, 132, permitting plate 90 to rest generally close to or against block 64 so that the plate does not press on back wall 150 of the track and prevent vertical movement of the sash in the window frame.

Preferably axis 40 coincides with axis 42.

When the sash is moved up and down in the window frame, channel 70 moves in track 154 vertically with the sash. Weight of the sash is transferred by bar 44 to block 64 and by block 64 to channel 70.

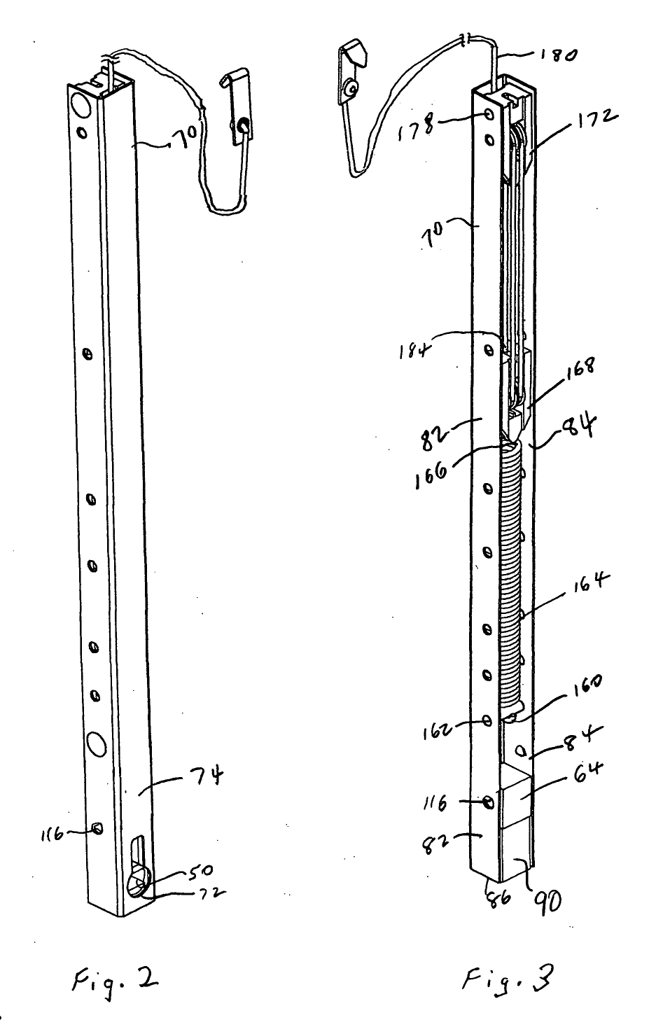

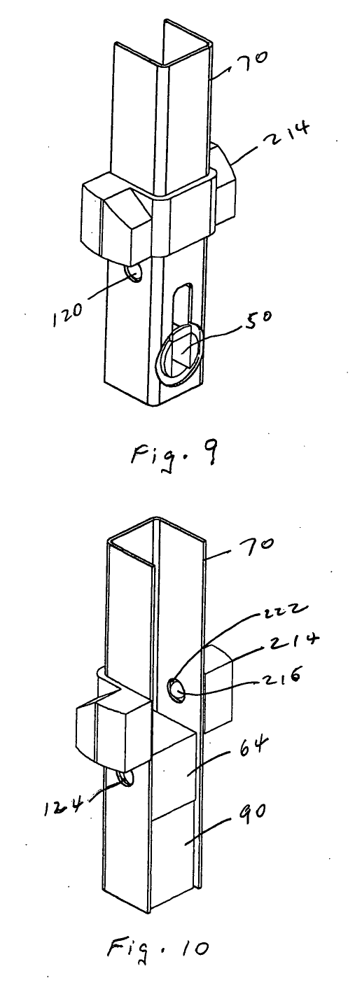

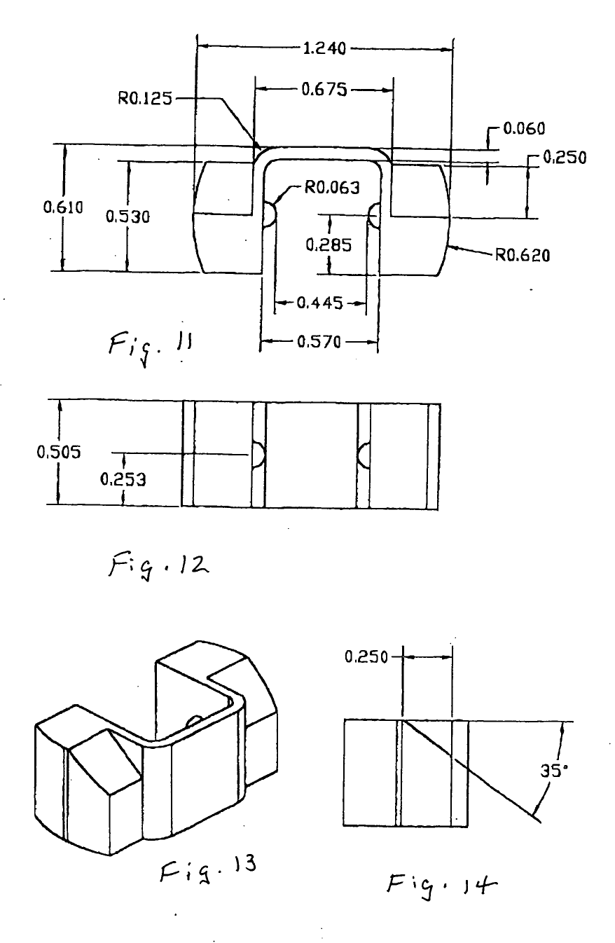

In FIGS. 3 and 8, end 160 of tension spring 164 is fixedly attached to channel 70 by rivet 162. End 166 of the spring is attached to pulley block 168 which can move vertically within channel 70. Pulley block 172 is fixedly attached to channel 70 by rivet 178.

End 184 of cord 180 is fixedly attached to pulley block 168 by knot 188. The cord passes around pulley 191, pulley 192 pulley 193, pulley 194 and extends out of channel 70. End 198 of the cord is attached to hood 204 which is attached to window frame 36 so that the block and tackle spring and pulley mechanism counterbalances the sash weight transferred to channel 70.

In FIGS. 4-7, 9, and 10, clip 214 slips onto the outside of channel 70. Bumps 216, 218 snap into holes 222, 224 through walls 84, 82 of channel 70. The clip is preferably made of plastic for reduced friction against the jamb track when channel 70 moves in the track.

A clip like 214 may be made with holes so that it can be riveted to channel 70. A clip like 214 may be made with holes and bumps for riveting or snap on to channel 70.

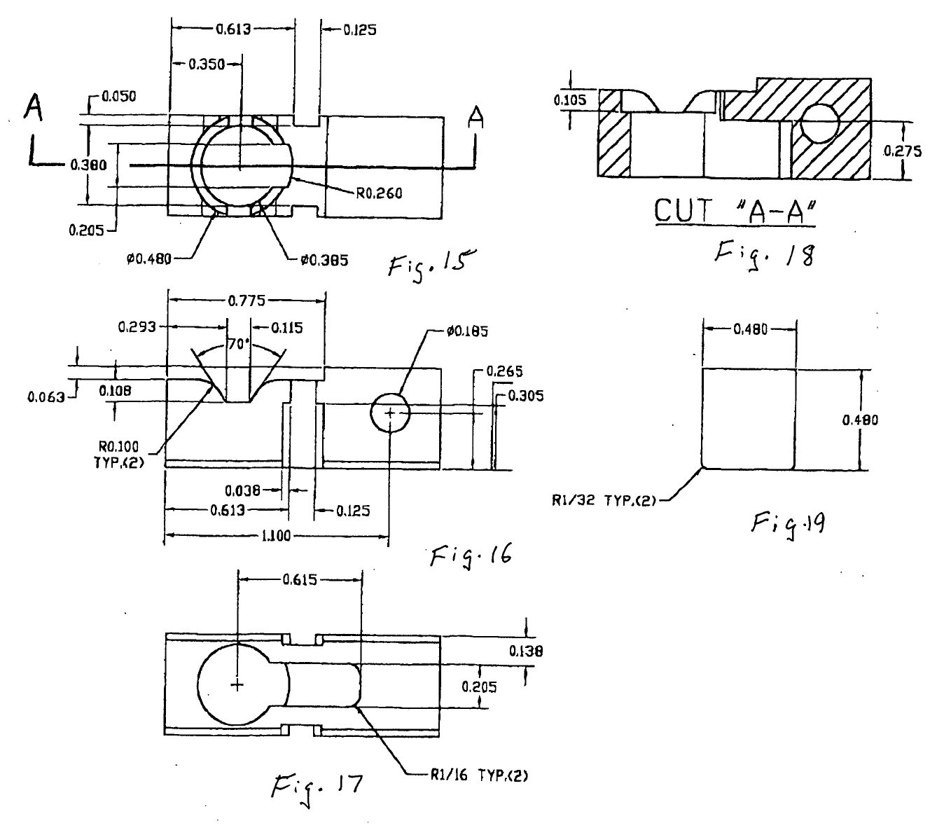

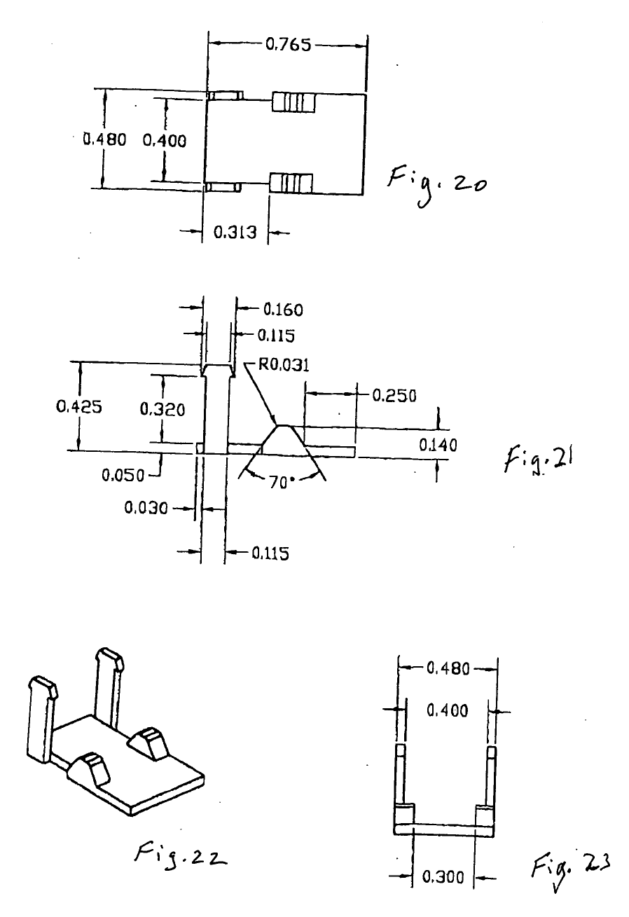

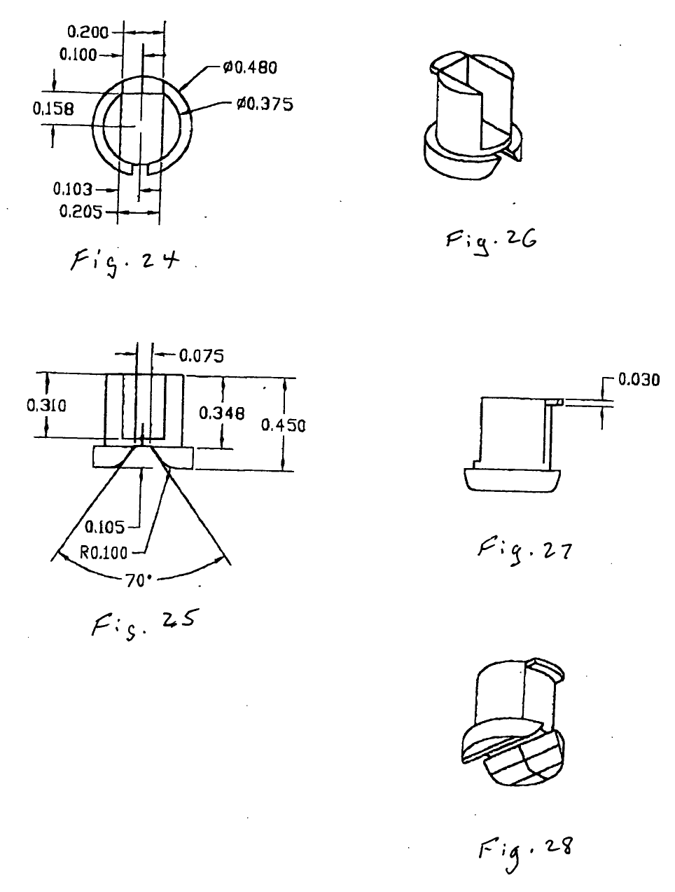

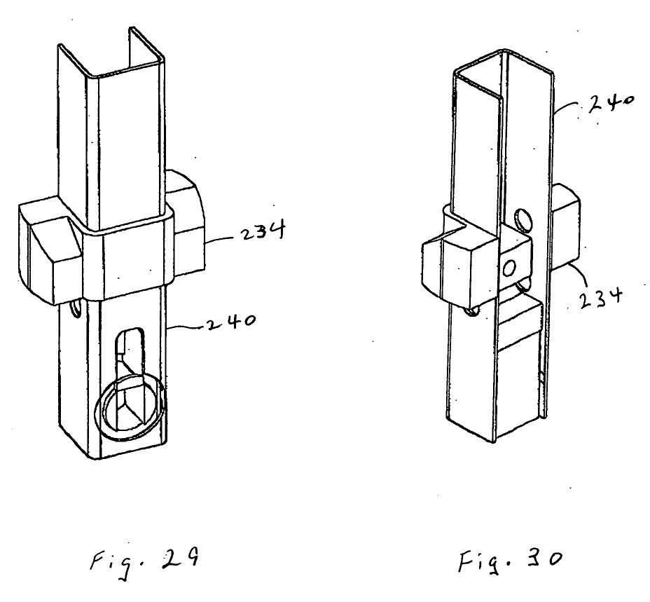

FIGS. 11-28 disclose dimensions in inches of various parts of one embodiment of the invention.

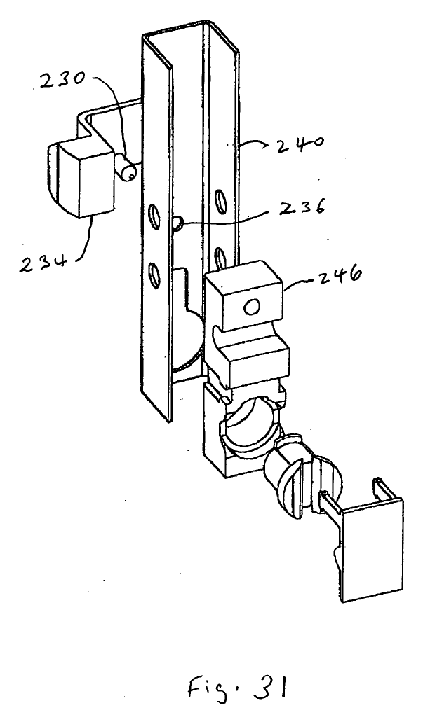

In FIGS. 29-31, protrusion 230 of clip 234 extends into hole 236 when the clip is mounted on channel 240. Protrusion 230 may be made to closely fit hole 236 in a friction grip. Clearance may be made in the front of block 246 over the hole for the protrusion to snap through the hole.

Although the present invention has been described with respect to details of certain embodiments thereof, if it is not intended that such details be limitations upon the scope of the invention. It will be obvious to those skilled in the art that various modifications and substitutions may be made without departing from the spirit and scope of the invention as set forth in the following claims.

What is claimed is:

1. A pivot sash block and tackle locking channel for preventing vertical movement of a window sash when in an open position, said pivot sash block and tackle locking channel comprising:
a channel;
a block adapted to slide within said channel, said block having a front surface including a substantially round opening extending through said block, said block having side surfaces each including a groove and a hole or indent;
a cam adapted to be inserted in said opening of said block, said cam having a substantially rectangular opening at a first end and a larger diameter opposite end having extending faces, said rectangular opening adapted to be joined with the window sash, said first end adjacent said front surface of said block during operation; and
a plate including fingers adapted to be removably retained within one of said grooves on said side surfaces, said plate also including riders, which contact said extending faces when said cam is rotated thereby causing said plate to extend outwardly away from said front surface of said block.

2. A pivot sash block and tackle locking channel for preventing vertical movement of a window sash when in an open position, said pivot sash block and tackle locking channel comprising:
a channel;
a block adapted to slide within said channel, said block having a front surface including a substantially round opening extending through said block;
a cam adapted to be inserted in said opening of said block, said cam having an opening at a first end and a larger diameter opposite end including extending faces, said opening adapted to be joined with the window sash, said first end adjacent to said front surface of said block during operation;
a plate including riders, which contact said extending faces when said cam is rotated thereby causing said plate to extend outwardly away from said front surface of said block; and
means for removably joining said plate with said block.

3. A pivot sash block and tackle locking channel according to claim 2, wherein said block further comprises side surfaces each including a hole or indent.

4. A pivot sash block and tackle locking channel according to claim 3, wherein said means for removably joining includes a groove in each of said side surfaces and fingers extending from said plate, which are removably retained within one of said grooves.

5. A pivot sash block and tackle locking channel according to claim 2, wherein said opening of said cam is substantially rectangular.

6. In a window frame track, a U-shaped channel having a front wall connecting a pair of side walls, said channel comprising a block, a cam rotatably mounted in said block, an axial opening in said cam generally concentric with an opening through said front wall, a sash attached to said cam by a bar extending through said opening through said front wall into said axial opening in said cam, a plate extendable from said block axially against said track contacting said cam.
